(19) United States
(12) Patent Application Publication
(10) Pub. No.: US 2025/0180399 A1
(43) Pub. Date: Jun. 5, 2025

(54) BALANCE HAVING A MAGAZINE AND A LOAD-CHANGE DEVICE

(71) Applicant: SARTORIUS LAB INSTRUMENTS GMBH & CO. KG, Goettingen (DE)

(72) Inventors: Falko HILBRUNNER, Ilmenau (DE); Thomas FROEHLICH, Ilmenau (DE); Mario SCHREIBER, Goesen (DE); Tim SCHULZ, Untermassfeld (DE); Thomas FEHLING, Witzenhausen (DE)

(21) Appl. No.: 19/043,788

(22) Filed: Feb. 3, 2025

Related U.S. Application Data
(63) Continuation of application No. PCT/EP2023/070287, filed on Jul. 21, 2023.

(30) Foreign Application Priority Data
Aug. 2, 2022 (DE) 10 2022 119 374.8

(51) Int. Cl. G01G 23/01; G01G 21/22; G01G 21/23; G01G 21/26

(52) U.S. Cl. CPC G01G 23/012; G01G 21/22; G01G 21/23; G01G 21/26

(57) ABSTRACT

A balance that includes a magazine for test weights (100) to be weighed in succession, a weighing device with a load carrier (200) holding a test weight (100) during an associated weighing operation, and a load changing device transferring the test weight to be weighed from the magazine to the load carrier. The magazine includes a motorized rotatable turntable (300), over the circumference of which the test weights are arranged distributed in test weight receptacles rotatable together with the turntable and with which the test weight receptacle carrying the test weight currently being weighed can be positioned in a weighing standby position above the load carrier. Each test weight receptacle is designed as a carrier gondola (400) mounted to the turntable in a manner vertically movable relative to the turntable and is adjustable in height relative to the turntable via a first motorized height adjustment unit (500, 500′).

### CROSS-REFERENCE TO RELATED APPLICATION

This is a Continuation of International Application PCT/EP2023/070287, which has an international filing date of Jul. 21, 2023, and the disclosure of which is incorporated in its entirety into the present Continuation by reference. This Continuation also claims foreign priority under 35 U.S.C. § 119 (a)-(d) to and also incorporates by reference, in its entirety, German Patent Application DE 10 2022 119 374.8 filed on Aug. 2, 2022.

### FIELD

The invention relates to a balance comprising
a magazine for test weights to be weighed in succession,
a weighing device with a load carrier for holding a test weight during an associated weighing operation, and
a load changing device for transferring the test weight currently to be weighed from the magazine to the load carrier,
   wherein the magazine comprises a motorized rotatable turntable, over the circumference of which the test weights can be arranged distributed in test weight receptacles rotatable together with the turntable and by which the test weight receptacle carrying the test weight currently to be weighed can be positioned in a weighing standby position above the load carrier.

### BACKGROUND

Such balances, in particular mass comparators, are known from DE 10 2015 104 693 A1.

Highly accurate precision balances are known as mass comparators, which are specially designed to compare weights of a certain nominal weight, sometimes referred to as check weights, with a corresponding mass standard, sometimes referred to as a reference weight. Check weights and reference weights should be summarized here under the term “test weights” without limiting the generality. Such mass comparators are used in particular for the calibration or verification of weights. Typically, the test weights are stored in a magazine and fed one after the other to the actual weighing device, in particular its load carrier, with a load changing device. A large number of test weights can be weighed automatically one after the other hereby. The specific structure of the actual weighing device is irrelevant in the context of the present application.

A mass comparator whose magazine is designed as a horizontally oriented turntable is known from the generic publication mentioned at the beginning. The test weights to be weighed in succession can be positioned on the upper side of the turntable at predetermined positions distributed around the circumference of the turntable. In the area of its outer circumference, the turntable is rotatably mounted on the front edge of a hollow cylindrical housing via several roller bearings. Inside the housing is the actual weighing device with an upward-facing load carrier. In particular, the load carrier is positioned such that each test weight receptacle can be positioned exactly above it by adjusting the angle of the turntable accordingly. This angular position of the turntable or the resulting angular position of the corresponding test weight receptacle is referred to here as the weighing standby position. In order to be able to transfer the test weight from its test weight receptacle to the load carrier, the actual weighing device in the known mass comparator is arranged on a lifting table, which can be moved upwards within the housing to such an extent that upwardly directed webs of the load carrier pass through corresponding slots of the test weight receptacle exactly above it, i.e. in its weighing standby position. This allows the test weight to be lifted off the test weight receptacle so that its weight force now acts directly on the load carrier. After the weighing process, the weighing device is lowered again with the lifting table so that the test weight is transferred back to the test weight receptacle. The weighing device is lowered to such an extent that the webs of the load carrier are completely released from the slots of the test weight receptacle. The turntable can then be rotated further until another test weight receptacle with a test weight located on it is positioned exactly above the load carrier, i.e. in its weighing standby position. The process described above can be repeated with the new test weight.

The skilled person will understand that, in the context of the present description, terms such as “up” and “down” refer to the operational orientation of the balance, i.e. are based on the direction of gravity. Accordingly, terms such as “raising” and “lowering” are to be understood as movements upwards and downwards respectively in this sense.

A disadvantage of the known mass comparator is that the actual weighing device is arranged on a movable element, namely the lifting table, which can lead to (minor) instabilities. In order to counter this problem, the aforementioned publication provides for the lifting table to be moved against a vertical stop, which largely, albeit not completely, solves the aforementioned problem. In addition, the mechanics of the lift table may require the use of lubricants, which means that the known system is not suitable for vacuum.

An alternative concept for a mass comparator is known from EP 3 255 393 A1, in which the actual weighing device is fixed to a base plate and the turntable can be adjusted both vertically and rotationally relative to this base. This has the disadvantage that the shaft of the turntable has to perform two different movement components. These are therefore coupled to each other and their bearing clearances interact, so that controlling them with the extremely high precision required for mass comparators is extremely demanding in terms of design and therefore expensive. The disadvantageous use of lubricants is also necessary here.

DE 10 2005 005 366 A1 discloses a device for transporting test weights from a magazine designed as a rotatable carrier ring to the load carrier of a lower-pan balance. The carrier ring has a plurality of positions for holding the test weights. Under each of these positions there are slot-shaped access openings and next to each position there is a hole in the carrier ring, the diameter of which is larger than that of the test weights. In order to transfer a test weight from the carrier ring to the load carrier, which is designed as a gondola reaching around the carrier ring, the carrier ring is rotated until the test weight comes to rest over the platform of the load carrier. Then the bolts of a lifting device located under the load carrier lift the test weight by reaching through both openings in the platform of the load carrier and the slot-shaped openings in the carrier ring. The carrier ring is then rotated until the adjacent hole in the carrier ring is above the platform of the load carrier and therefore under the test weight. The lifting device then lowers the test weight onto the load carrier by retracting its bolts.

### SUMMARY

It is an object of the present invention to further develop a conventional balance, in particular a conventional mass comparator, so that, while retaining the decoupling of vertical and rotational movement components and achieving maximum positioning precision, the result is a system that is also fundamentally suitable for vacuum applications.

This and other objects are achieved in conjunction with the features as claimed and/or described herein. According to one formulation, each test weight receptacle is configured as a carrier gondola mounted to the turntable in a manner vertically movable relative to the turntable and is adjustable in height relative to the turntable with a first motorized height adjustment unit.

One important aspect of the present invention is to design each individual test weight receptacle to be vertically adjustable by motor instead of the entire magazine or the actual weighing device in order to adjust the height of the test weights, which is necessary when transferring them to the load carrier. In other words, each individual test weight receptacle can be individually moved vertically relative to the turntable and the load carrier. This means that the turntable as such does not have to perform any vertical movements, so that its bearing and drive can be configured solely for its rotational movement component. Any vertical movement component can be completely eliminated for the turntable as such. At the same time, the actual weighing device does not need to be raised or lowered. As a result, it can be fixed to a foundation as stably as required. By dispensing with any rough movement mechanism, there is also no need to use lubricants, so that the resulting balance is basically vacuum-compatible.

Preferably, each carrier gondola is spring-biased upwards against an associated stop fixed to the turntable and can be lowered downwards with a force applied by the first motorized height adjustment unit against the spring biasing force. The spring force of the biasing spring should exceed the weight of the carrier gondola and the test weight positioned on it during operation. Hereby the highest position of the carrier gondola is precisely defined via this stop. This position of the carrier gondola can be referred to as the rest position. Each carrier gondola is initially in its rest position. This also applies in particular to the carrier gondola with the test weight currently to be weighed, which is positioned above the load carrier by rotation of the turntable into the respective weighing standby position. From this rest position, the carrier gondola must now be lowered downwards in order to transfer the test weight to the load carrier. This lowering is motorized via the first motorized height adjustment device. The interaction between the test weight receptacle, the test weight and the load carrier during the actual weight transfer can follow the known principles. For example, it is preferable for the platform of the carrier gondola to be provided with slots through which corresponding webs of the load carrier protrude when the carrier gondola in its weighing standby position is lowered. When the carrier gondola is lowered, the webs of the load carrier therefore move under the bottom of the test weight and lift it from its test weight receptacle, i.e. from the platform of the carrier gondola. After the weighing process, the force of the first motorized height adjustment device is switched off or at least is reduced to such an extent that the carrier gondola is raised again by the spring force of the biasing spring and is returned to its rest position.

The specific mechanism for vertical movement of the carrier gondolas can be realized in different embodiments. An embodiment in which the carrier gondola is articulated to the turntable with a parallel link arrangement, the fixed end of which is fixed to the turntable and the movable end of which is fixed to the carrier gondola, is regarded as particularly advantageous. Parallel link arrangements, which are also used within so-called weighing systems, in particular as Roberval mechanisms, are known in detail to skilled persons in the relevant field of weighing technology. They essentially consist of a horizontal upper link, a parallel lower link and a rigid coupling beam on each end of this pair of links that connects the respective ends of the two links. In contrast to a simple bending beam, when the parallel link arrangement is deflected, the spatial alignment of the coupling beam at the movable end remains exactly the same, while it performs a (slightly curved) vertical movement. The upper and lower links can be rigid and hinged to the respective coupling beam. In this case, it is possible to form the parallel link arrangement as a monolithic unit and to configure the joints as material thin sections. Alternatively, it is possible to configure the upper and lower links as cantilever springs rigidly fixed to the coupling beam. In either case, there are no frictional sliding contact surfaces, as would be the case, for example, if the carrier gondola were mounted on vertical guide rods or toothed racks.

The parallel link arrangement is preferably adjusted such that in the rest position, i.e. in particular when resting against the stop described above, the upper and lower links are deflected slightly upwards from their exact horizontal position. This exact horizontal position should preferably be achieved in the lowered stage in which the actual transfer of the test weight from the carrier gondola to the load carrier takes place. At this stage, the error introduced by the circular movement of the movable coupling beam is at its lowest: here the horizontal movement component is close to zero.

The most space-saving variant for implementing this embodiment of the invention is the suspended articulation of the carrier gondolas below the turntable. In this arrangement, the fixed end of each parallel link arrangement is fixed to the underside of the turntable. Of course, other designs can also be realized with the corresponding additional expenditure of installation space and mechanics. For the sake of simplicity, however, the following description will focus on the above-mentioned design with suspended carrier gondolas, although the skilled person will be able to transfer the corresponding designs to other variants without further ado.

In principle, it is conceivable to equip each carrier gondola with its own motorized drive. This would be located between the carrier gondola or the free end of the parallel link arrangement and the turntable and would be mechanically connected to both elements. However, this can have unfavorable thermal effects. Heat is generated at every motorized drive during operation. For high-precision gravimetric measurements, however, the temperature constancy of the system is important. In such an embodiment, the heat input would therefore have to be compensated for thermodynamically or mathematically. A more favorable and here preferred embodiment, on the other hand, provides for the first motorized height adjustment unit to be mechanically unconnected to the turntable. The rotary actuator can therefore rotate relative to the first motorized height adjustment unit and feed each test weight receptacle individually. The first motorized height adjustment unit can then be configured such that it can only act on the carrier gondola in the weighing standby position.

In particular, it can be provided that the first motorized height adjustment unit has an eccentric cam which is fixed on a motor-driven rotatable camshaft, the cam being arranged such that a plunger connected in a vertically force-transmitting manner to the carrier gondola currently located in the weighing standby position is located in the range of movement of the cam, so that the plunger can be mechanically depressed by rotation of the camshaft via the cam. The motor driving the camshaft can be arranged outside a thermally insulated and possibly evacuated central area of the overall system. As a result, its operation does not generate any heat in the area of the test weights or the actual weighing device. Instead, this critical central area only contains a mechanical interaction pair of cam and plunger, whereby the plunger is fixed to the carrier gondola itself or to the parallel link arrangement.

Particularly in the variant with suspended carrier gondolas described above as preferred, it can be provided that the camshaft runs above the turntable, parallel to it and offset to its axis of rotation, the carrier gondolas are mounted suspended below the turntable and their respective plungers protrude into or through an associated opening in the turntable. In this embodiment, the mechanical interaction between the first motorized height adjustment unit and the carrier gondola (in its weighing standby position), in particular between the cam and the plunger, takes place through the turntable. In particular, the first motorized height adjustment unit can be arranged in the largely free area above the turntable, where, unlike below the turntable where the carrier gondolas are arranged, sufficient installation space is available.

The turntable is preferably axially supported on a plurality of roller bearings distributed around its circumference and acting upwards onto its underside. In particular, it is considered favorable if the turntable is axially supported by exactly three roller bearings. The roller bearings are loaded with the weight of the entire magazine, which results in a vertically or axially very stable bearing. The preferred choice of exactly three roller bearings for the axial bearing of the turntable results from the associated exact determination of the turntable plane.

With regard to the radial bearing of the turntable, it is preferably provided that it is radially supported by a plurality of roller bearings distributed over its circumference and acting radially inwards onto its circumferential surface. It is preferable that the turntable is radially supported by exactly three roller bearings, two of which are configured as fixed bearings and one as a spring-loaded floating bearing. This ensures that even in the event of (minor) wear, the bearing is always precise and therefore ensures that the rotary plate always rotates reproducibly.

To drive the turntable, it is preferable for it to be driven via a motor-driven friction wheel rolling on its surface. One advantage of the friction wheel drive is that the maximum torque is limited by the slip of the friction wheel on the surface of the turntable, which ensures greater accident safety in contrast to toothed drives, such as a toothed belt or gear drive. However, such drives as well as a friction belt drive, for example, can also be used in principle within the scope of the invention. At least due to the slip, it is considered advantageous to equip the turntable with a rotational position indicator. This allows high reproducibility of the transfer of each test weight pick-up to the weighing standby position. In the case of slip-free drive variants, this reproducibility can be ensured by precise motor control alone.

In the preferred embodiment of the friction wheel drive, the friction wheel rolls on the upper side of the turntable and is fixed on a motorized rotatable drive shaft arranged above the turntable and perpendicular to its axis of rotation. In contrast to when the friction wheel rolls on the circumferential surface or the underside of the turntable, the pressure exerted by the friction wheel on the turntable in this preferred embodiment cannot cause any interference with the bearing of the turntable, which is located there. However, rolling the friction wheel on the circumferential surface offers potential savings in that one of the radial bearings of the turntable, in particular the floating bearing, can be configured as a roller bearing and perform a corresponding dual function. The motor driving the drive shaft can itself be arranged outside the central area of the overall system, in particular outside a thermally insulated core. As already explained above in the context of the camshaft, this prevents the undesired entry of heat into its central area of the system.

The function of the carrier gondolas was only explained above in the context of transferring the test weights to the load carrier. However, the same principle can also be used to load the carrier gondolas with test weights from an external test weight store or when emptying the magazine into this external test weight store. First of all, it is envisaged that a loading unit is arranged at an angle offset to the load carrier with respect to the axis of rotation of the turntable, via which loading unit the magazine can be loaded with weights from a weights store as test weights. The carrier gondola lowering mechanism is preferably provided in double for this purpose. In other words, it is preferable that, in addition to the first motorized height adjustment unit, a second motorized height adjustment unit of the same type is provided, which is only able to act on the carrier gondola that is currently in a loading standby position above a feed element of the loading unit that can be moved radially to the turntable. At the loading unit, the vertical adjustment of the carrier gondola then interacts with a test weight conveyor that can be moved radially (in relation to the turntable). For loading, an empty carrier gondola is first rotated into the loading standby position and then lowered. The feed element fitted with a test weight moves radially inwards from the test weight bearing and positions the test weight above the floor of the carrier gondola. This is then raised again and takes the test weight, whereby the slots in the base of the carrier gondola also interact here with the webs of the feed element without collision. The feed element is then moved radially outwards again and the next carrier gondola is moved into the loading standby position by rotating the turntable. To unload the carrier gondolas, the interaction with the feed element is reversed, in particular (with the exception of the radial displacement) analogous to the transfer of test weights to the load carrier, as described above. Of course, it is also possible to combine unloading and loading of a carrier gondola in a single process in which the test weight is exchanged in this carrier gondola.

Further details and advantages of the invention can be seen from the following special description and the drawings.

### BRIEF DESCRIPTION OF THE DRAWINGS

FIG. 1: A perspective view of an embodiment of the load changer of a balance according to the invention,

FIG. 2: a schematic sketch of the load change principle according to the invention,

FIG. 3: a schematic sketch of a preferred embodiment of the height adjustment unit according to the invention,

FIG. 4: a schematic top view of one embodiment of the turntable of a balance according to the invention,

FIG. 5: a schematic sectional view of an embodiment of the turntable of a balance according to the invention,

FIG. 6: a perspective view of an embodiment of the load carrier of a balance according to the invention,

FIG. 7: a perspective view of an embodiment of the platform of a carrier gondola of a balance according to the invention and

FIGS. 8A-8C: a schematic sketch of three points in the loading process of a carrier gondola of an embodiment of a balance according to the invention.

### DETAILED DESCRIPTION

Identical reference signs in the figures indicate identical or analogous elements.

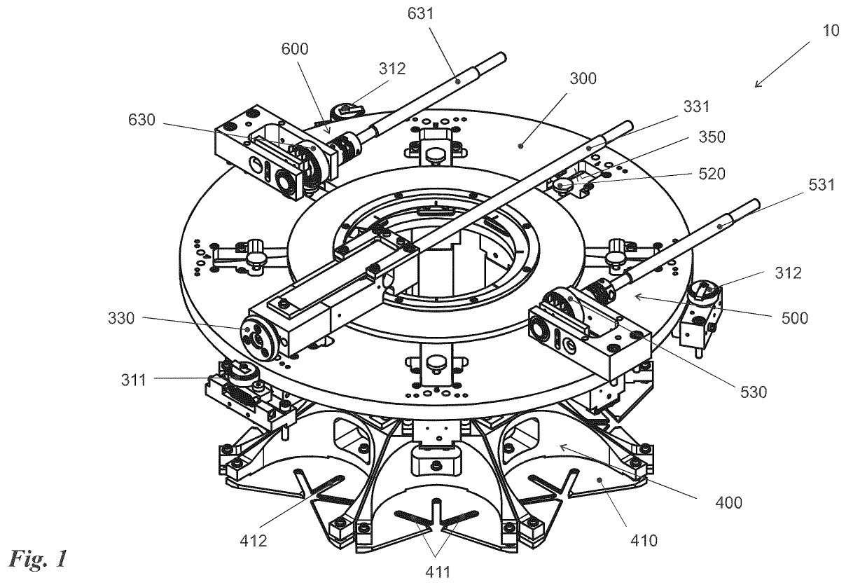

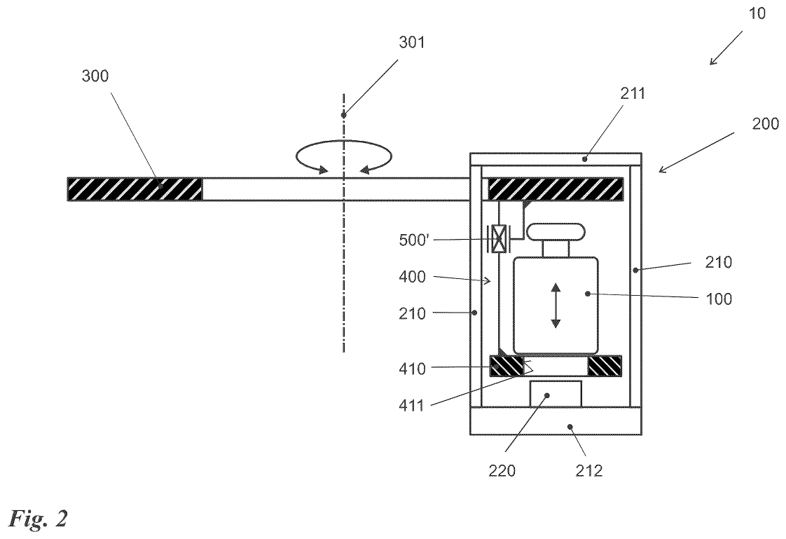

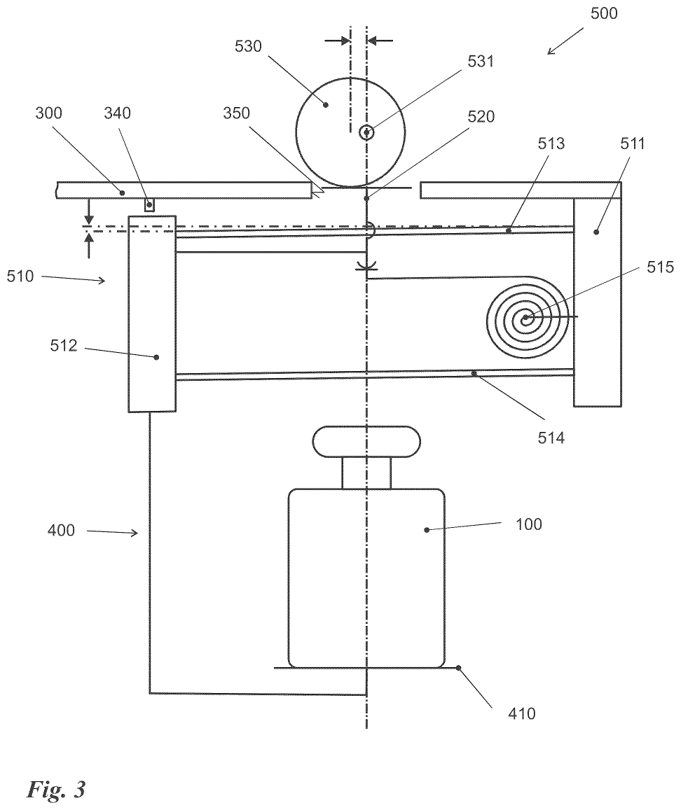

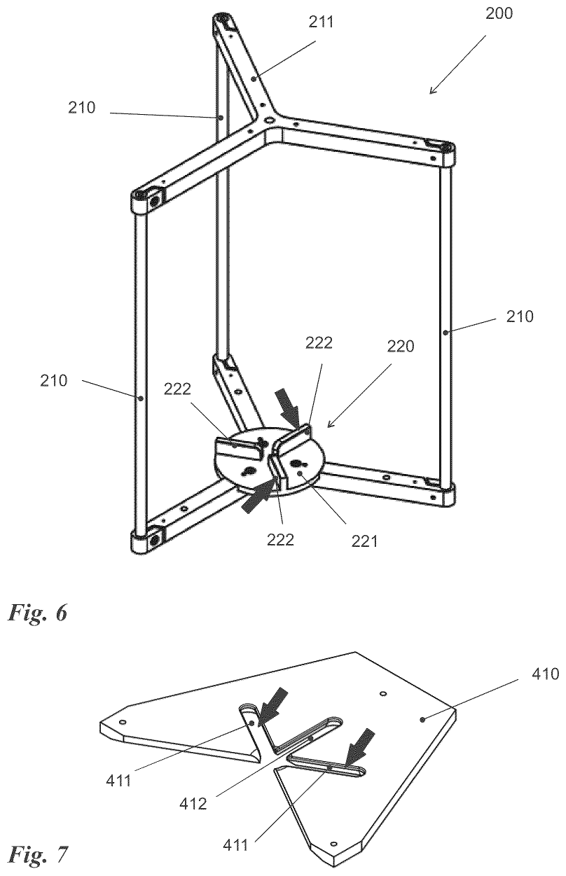

FIG. 1 shows a perspective view of a preferred embodiment of the load changer 10 of a balance according to the invention. The load changer 10 shown combines the function of a magazine for test weights 100, not shown in FIG. 1 but shown in FIGS. 2 and 3, and the function of the actual load changing device for transferring the test weight 100 currently to be weighed from the magazine to a load carrier 200, not shown in FIG. 1 but shown in FIG. 6, of an actual weighing device, in particular a mass comparator, which is otherwise not shown. The load changer 10 will be described below, primarily with reference to FIG. 1, whereby reference will be made to the other figures for a description of individual elements.

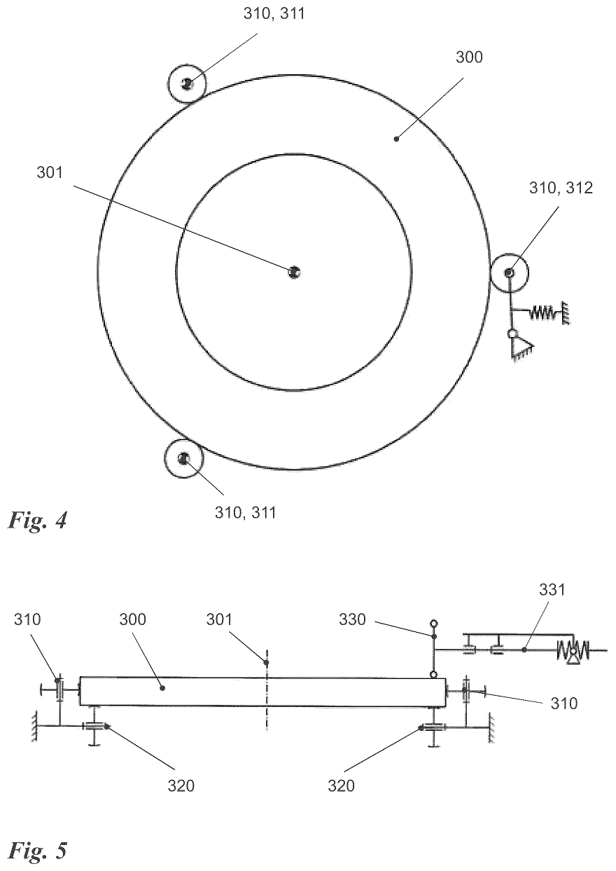

An essential structural element of the functional unit “magazine” is the turntable 300. The turntable 300 is mounted for rotation about a central, vertically aligned axis of rotation 301 (see FIG. 2) in a horizontal turntable plane. Preferably, as can be seen in particular from FIGS. 4 and 5, its radial bearing is provided by a radial roller bearings 310 engaging on its circumferential surface. The particularly preferred embodiment of this bearing arrangement is shown in FIG. 4. Here, exactly three radial roller bearings 310 are used, two of which are configured as fixed bearings 311 and one as a spring-biased floating bearing 312. As can be seen in particular from the highly schematized representation of FIG. 5, the axial bearing arrangement of the turntable 300 is effected by axial roller bearings 320 engaging on its underside. In a manner not shown, the axial roller bearings 320 are distributed evenly over the circumference of the turntable 300, analogous to the distribution of the radial roller bearings 310 shown in FIG. 4, with exactly three axial roller bearings 320 preferably being used.

As shown in FIG. 5, the rotary drive of the turntable 300 is preferably embodied through a friction wheel 330 rolling on the upper side of the turntable 300, which can be driven by a motor, not shown, via a drive shaft 331. As shown in FIG. 1, the drive shaft 331 preferably runs above the turntable 300 and perpendicular to its axis of rotation 301. The drive shaft 331 can be of almost any length, so that the associated motor can be positioned far outside the load changer 10 in order to avoid any motor-related heat input into this “heart” of the balance according to the invention.

The design of the bearing and drive of the turntable 300 described above allows it to be configured in the shape of an annular disk. This in turn permits an eccentric arrangement of the load carrier 200 shown in FIG. 2, which can preferably assume the configuration shown in FIG. 6 as a cage for this purpose. In the embodiment shown, the cage of the load carrier 200 comprises several, in particular three vertical rods 210, which are connected to each other by an upper star 211 and a lower star 212 to form the cage. In the case of a bottom pan design of the actual weighing device, the load carrier 200 can be hinged at the center of its upper star 211 to the load receptor of the weighing system. In the case of an top pan design of the actual weighing device, the coupling of the load carrier 200 with the load receptor of the weighing system takes place in the central area of the lower star 212. In any case, a test weight adapter 220 is arranged in the central area of the lower star 212, on which the test weight 100 currently to be weighed is to be positioned for the weighing process. In the embodiment shown, the test weight adapter 220 essentially consists of an adapter plate 221, from which three radially aligned webs 222 protrude at an angle of 120° to each other. The function of the webs 222 will be discussed in more detail below.

Several individually height-adjustable support gondolas 400 are arranged on the underside of the turntable 300, distributed around its circumference. Each of these has a platform 410 corresponding in shape to the test weight adapter 220. A perspective view of a preferred embodiment of such platform 410 is shown in FIG. 7. A test weight 100 is placed on each of these platforms 410 during operation, as can be seen in particular in FIGS. 2 and 3. As can be seen in particular from FIG. 7, the platform 410 is provided with slots 411 passing through it, which are adapted in shape and orientation to the webs 222 of the test weight adapter 220 of the load carrier 200. Details of this will be discussed in more detail below.

First, the basic principle of a load changer 10 with individually height-adjustable carrier gondolas 400 will be described with reference to FIG. 2. By suitable rotation of the turntable 300, a selected carrier gondola 400 with the test weight 100 positioned on its platform 410 can be moved into its weighing standby position, in which it is positioned above the test weight adapter 220 of the weighing carrier 200. The skilled person will understand that when, in the context of the present description, it is referred to in a simplified manner that the test weight or the carrier gondola is arranged “above the weighing carrier”, this relative positioning specification refers only to the area of the weighing carrier intended for directly receiving the test weight, i.e. in the embodiment shown, its weighing adapter 220. The fact that other areas of the load carrier 200, in particular the upper star 211 in the embodiment shown, may in turn be arranged higher than the test weight or the carrier gondola, is not intended to contradict this. Thus, in the embodiment shown, the platform 410 of the carrier gondola 400 with the test weight 100 currently to be weighed is in its weighing standby position within the cage of the load carrier 200 above its test weight adapter 220. This situation is illustrated in FIG. 2. In this weighing standby position, the carrier gondola 400 can be lowered relative to the turntable 300 (including all other carrier gondolas 400) and relative to the weighing carrier 200 with a height adjustment unit 500, 500′. During lowering, the slots 411 of the platform 410 are penetrated by the test weight adapter 220, in particular by its webs 222. When the carrier gondola 400 is lowered sufficiently, the test weight 100 is transferred from the platform 410 to the test weight adapter 220 so that the weight of the test weight 100 now rests solely on the weighing carrier 200 so that a weighing process can be carried out using the actual weighing device. The height adjustment unit 500′ in FIG. 2 is shown purely schematically as a small motor unit, of which each carrier gondola 400 has its own. However, this does not correspond to the preferred embodiment of the invention. This is shown in perspective in FIG. 1 and highly schematized in FIG. 3.

As can be seen from FIG. 3, in the preferred embodiment of the height adjustment unit 500, the carrier gondola 400 is articulated to the underside of the turntable 300 with a parallel link arrangement 510. The parallel link arrangement 510 comprises a first coupling beam 511 fixed to the turntable 300 and a second coupling beam 512 fixed to the carrier gondola 400, which are connected to one another through an upper link 513 and a lower link 514 extending parallel to each other. The links 513, 514 are connected to the coupling beams 511, 512 in an articulated manner, whereby joints formed as monolithic material thin sections are preferably used. Alternatively, the links 513, 514 could be configured as cantilever springs rigidly connected to the coupling beams 511, 512. With a biasing spring 515, shown here as a spiral spring, the parallel link arrangement 510, in particular its second coupling beam 512 with the carrier gondola 400, is spring preloaded upwards, whereby a stop 340 on the turntable ensures an exact definition of the maximum raised position of the parallel link arrangement 510 or the carrier gondola 400. A plunger 520 rigidly connected to the second coupling beam 512 projects into an aperture 350 of the turntable 300 or extends completely through it. In either case, the plunger 520 provides a contact surface for a force acting vertically on it, via which the parallel link arrangement 500 can be deflected against the spring force of the biasing spring 515 and the carrier gondola 400 can thereby be lowered. In the embodiment shown, this vertical force is exerted by a cam 530, which is fixed on a camshaft 531. In the embodiment shown, the cam 530 is configured as a wheel fixed eccentrically on the camshaft 531. Of course, non-rotationally symmetrical cam shapes are also conceivable. As can be seen in particular from FIG. 1, the camshaft 531 preferably runs parallel to the plane of the turntable and offset to its axis of rotation 301. In particular, it runs parallel to the drive shaft 331 of the turntable drive. As described above in the context of the drive shaft, it is also possible in connection with the camshaft 531 to move the motor driving it far to the radial outside in order to avoid corresponding heat input into the “heart” of the balance according to the invention.

In the embodiment shown, a second height adjustment unit 600 is arranged opposite the first height adjustment unit 500 (in relation to the axis of rotation of the turntable 300). This works exactly the same as the first height adjustment unit 500, so that there is no need to describe it again here. FIG. 1 shows its cam 630 and its camshaft 631. The background to the double design is that the embodiment shown in FIG. 1 not only permits automated lowering of the carrier gondolas 400 for transferring the test weights 100 to the weighing goods carrier 500, but also automatic loading of the carrier gondolas 400 with test weights 100 from a test weight store not shown.

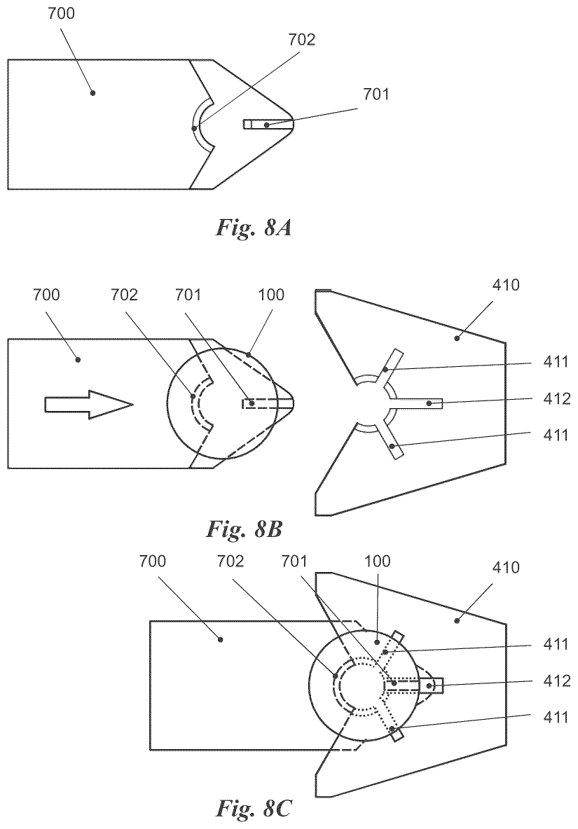

Such a loading process is illustrated in FIGS. 8A-8C. Connected to the test weight bearing is a feed element 700, which is configured here as a feed tongue and can be moved linearly and in particular radially to the turntable. The tip of the feed element 700 is provided with a radial web 701 and a partially circular web 702, which protrude upwards from the plane of the tongue and serve as the actual support for the test weights 100. A test weight 100, as illustrated in FIG. 8B, is placed on these webs 701, 702 to equip a carrier gondola 400. A carrier gondola 400, of which only the platform 410 is shown in FIGS. 8B and 8C, can then be loaded in its loading standby position, i.e. with its plunger exactly under the cam 630. As already described above in the context of FIGS. 6 and 7, the platform 410 of the support gondola 400 has slots 411 through which corresponding webs 222 of the test weight adapter 220 of the weighing goods carrier 200 engage when the support gondola is lowered into its weighing standby position. These slots 411 or webs 222 are indicated by black arrows in FIGS. 6 and 7. However, the platform 410 also has an additional slot 412, which plays no role in the transfer of the test weight to the load carrier 200. However, it is required for transferring the test weight as part of the assembly illustrated in FIGS. 9A-8C. When the carrier gondola 400 is lowered, the feed element 700 loaded with the test weight 100 is positioned at a height relative to its platform 410 such that the tongue plane of the feed element, from which its webs 701, 702 protrude, is lower than the underside of the platform 410 of the carrier gondola 400, although the upper edges of the webs 701, 702 are higher than the upper side of the platform 410. In this relative position, the feed element, as indicated by the white arrow in FIG. 8B, is displaced linearly towards the carrier gondola 400, with its linear web 701 moving into the additional slot 412 of the carrier base 410, resulting in the constellation shown in FIG. 8C. From this position, the carrier gondola 400 can be lifted again and takes over the test weight 100 from the feed element 700.

The embodiments discussed in the specific description and shown in the figures are only illustrative examples of the present invention. In the light of the present disclosure, the skilled person is provided with a wide range of possible variations.

### LIST OF REFERENCE SYMBOLS

10 load changer
100 test weight
200 load carrier
210 vertical bar
211 upper star
212 lower star
220 test weight adapter
221 adapter plate
222 web
300 turntable
301 rotation axis
310 radial roller bearing
311 fixed bearing
312 floating bearing
320 axial roller bearing
330 friction wheel
331 drive shaft
340 stop
350 breakthrough
400 carrier gondola
410 platform
411 slot
412 slot
500 height adjustment unit
500′ height adjustment unit
510 parallel link arrangement
511 coupling beam
512 coupling beam
513 upper link
514 lower link
515 biasing spring
520 plunger
530 cam
531 camshaft
600 Height adjustment unit
630 cam
631 camshaft
700 feeder element
701 web
702 web

What is claimed is:

1. A balance comprising
a magazine configured to support test weights to be weighed in succession in a weighing operation,
a weighing device with a load carrier configured to hold one of the test weights during the weighing operation, and
a load changing device configured to transfer the at least one test weight from the magazine to the load carrier,
wherein the magazine comprises a motorized rotatable turntable having a circumference over which the test weights are arranged distributed in test weight receptacles rotatable together with the turntable and with which the test weight receptacle carrying the test weight being weighed is positioned in a weighing standby position above the load carrier,
wherein each test weight receptacle
is configured as a carrier gondola mounted to the turntable and vertically movable relative to the turntable and
is adjustable in height relative to the turntable through a first motorized height adjustment unit.

2. The balance according to claim 1,
wherein each carrier gondola is spring-biased upwards with a spring-biasing force against an associated stop fixed to the turntable and
is configured to lower downwards via a force applied by the first motorized height adjustment unit counter to the spring-biasing force.

3. The balance according to claim 1,
wherein each carrier gondola is articulated to the turntable through a parallel link arrangement having a fixed end and a moveable end, and wherein the fixed end is fixed to the turntable and the movable end is fixed to the carrier gondola.

4. The balance according to claim 1,
wherein the first motorized height adjustment unit is mechanically unconnected to the turntable and is configured to act only on the carrier gondola located in the weighing standby position.

5. The balance according to claim 4,
wherein each carrier gondola is articulated to the turntable through a parallel link arrangement having a fixed end and a moveable end, and the fixed end is fixed to the turntable and the movable end is fixed to the carrier gondola, and
wherein the first motorized height adjustment unit has an eccentric cam which has a range of movement and is fixed on a motor-driven rotatable camshaft, the cam being arranged such that a plunger connected in a vertically force-transmitting manner to the carrier gondola located in the weighing standby position is located in the range of movement of the cam, so that the plunger is mechanically depressed by rotation of the camshaft via the cam.

6. The balance according to claim 5,
wherein the camshaft runs above the turntable, in parallel thereto and offset to an axis of rotation of the turntable, and wherein a respective one of the carrier gondolas is suspended below the turntable and the respective plunger projects into or through a respective associated aperture of the turntable.

7. The balance according to claim 1,
wherein the turntable is axially supported on a plurality of roller bearings distributed over the circumference and acting upwards onto an underside of the turntable.

8. The balance according to claim 7,
wherein the turntable is axially supported on three roller bearings.

9. The balance according to claim 1,
wherein the turntable is radially supported by a plurality of roller bearings distributed over the circumference and acting radially inwards onto a circumferential surface of the turntable.

10. The balance according to claim 9,
wherein the turntable is radially supported by exactly three roller bearings, two of which are configured as fixed bearings and one of which is configured as a spring-biased floating bearing.

11. The balance according to claim 1,
wherein the turntable is configured to be driven by a motor-driven friction wheel rolling on a surface of the turntable.

12. The balance according to claim 11,
wherein the friction wheel rolls on an upper side of the turntable and is fixed on a motor-rotatable drive shaft arranged above the turntable and perpendicular to an axis of rotation of the turntable.

13. The balance according to claim 1,
wherein a platform of the carrier gondola comprises slots through which, in a lowered state of the carrier gondola in the weighing standby position, corresponding webs of the load carrier project.

14. The balance according to claim 1,
further comprising a loading unit arranged at an angle offset to the load carrier with respect to an axis of rotation of the turntable, with which loading unit the magazine is loaded with weights from a weights store as test weights.

15. The balance according to claim 14,
wherein the first motorized height adjustment unit is mechanically unconnected to the turntable and is configured to act only on the carrier gondola located in the weighing standby position, and further comprising a second motorized height adjustment unit, which is configured to act only on that one of the carrier gondolas which is in a loading standby position above a feed element of the loading unit which is moved radially to the rotary plate.
